(19) United States
(12) Patent Application Publication
(10) Pub. No.: US 2024/0394328 A1
(43) Pub. Date: Nov. 28, 2024

(54) Ising Model Calculator

(71) Applicant: Nippon Telegraph and Telephone Corporation, Tokyo (JP)

(72) Inventors: Hiroki Takesue, Musashino-shi, Tokyo (JP); Takahiro Inagaki, Musashino-shi, Tokyo (JP); Toshimori Honjo, Musashino-shi, Tokyo (JP); Kensuke Inaba, Musashino-shi, Tokyo (JP); Yasuhiro Yamada, Musashino-shi, Tokyo (JP); Takuya Ikuta, Musashino-shi, Tokyo (JP); Yuya Yonezu, Musashino-shi, Tokyo (JP)

(21) Appl. No.: 18/681,314

(22) PCT Filed: Aug. 25, 2021
(86) PCT No.: PCT/JP2021/031192

§ 371 Date: Feb. 5, 2024

(51) Int. Cl. G06F 17/11

(52) U.S. Cl. CPC G06F 17/11

(57) ABSTRACT

A calculation device that simulates spin states of a finite-temperature Ising model by combining characteristics of a coherent Ising machine and an electronic calculator is provided. The calculation device includes a coherent Ising machine including a sampling unit that samples a spin state, the sampling unit introducing a check spin for extracting a sample in addition to a target spin for solving a target problem for which a solution of the Ising model is to be obtained, and an electronic calculator including a temperature estimation unit that calculates a temperature or an inverse temperature of a sample in a spin state extracted by the sampling unit, and an integration processing unit that integrates a plurality of samples and performs statistical processing.

### TECHNICAL FIELD

The present invention relates to a calculation device for an Ising model, and more particularly to a calculation device for a hybrid Ising model that simulates a spin state of a finite-temperature Ising model.

### BACKGROUND ART

Magnetic materials are a typical substance exhibiting a phase transition that has been studied in physics for a long time. In addition, magnetic materials are important in practical use, and for example, ferromagnetic materials are used as permanent magnets in industrial fields and daily lives. A mathematical model called an Ising model is used for theoretical analysis of magnetic materials having easy-axis-type magnetic anisotropy such as a ferromagnetic material. The energy of the Ising model is expressed by the following Hamiltonian in which discrete variables σᵢ and σⱼ having binary degrees of freedom of +1 and −1, which are called spins, are combined on a network including an adjacency matrix Jᵢⱼ.

$$H = - {\sum }_{ij} {J}_{ij} {σ}_{i} {σ}_{j} \qquad [ Math . 1 ]$$

Physical properties of a finite-temperature magnetic material can be statistically calculated by using a canonical distribution of spin states having an energy determined by the Hamiltonian described above. This calculation is analytically possible when the adjacency matrix Jᵢⱼ (coupling constant) indicating the correlation of the respective sites constituting the Ising model is very simple, and an exact solution may be ascertained. On the other hand, when the structure becomes complicated, analytical calculation of statistics becomes difficult, and numerical simulation using an electronic calculator or the like becomes necessary. In fact, analysis of the finite-temperature Ising model having a network structure with a high degree of freedom is required in order to seek a material design or new physical properties of a high-performance magnetic material having a high transition temperature, a high coercivity, and the like. Therefore, analysis with a very large amount of calculation, such as a numerical simulation using pseudorandom numbers by a Markov chain Monte Carlo method or the like using an electronic calculator is required.

Meanwhile, a degenerate optical parametric oscillator is a device that converts coherent light having isotropic amplitude fluctuation into squeezed light having fluctuation biased in a specific phase direction due to a second-order nonlinear optical response. The fluctuation is caused by quantum mechanical uncertainty, and when the sign of the amplitude is measured, the fluctuation has a physical random number taking complete random values of +1 and −1. Furthermore, since the fluctuation is biased in a specific direction, its randomness is stable, without being affected by an external factor. As a result, the degenerate optical parametric oscillator is a device that stably generates a binary degree of freedom corresponding to the spins described above.

FIG. 1 illustrates a basic configuration of a conventional coherent Ising machine. The coherent Ising machine injects pump light pulses into a phase sensitive amplifier (PSA) 2 provided in a ring-shaped optical fiber functioning as a ring resonator 1 to generate a train of light pulses in the number corresponding to the number of sites of the Ising model. When the light pulse train input to the ring resonator 1 makes one round and reaches the PSA 2 again, the pump light is input to the PSA 2 again to amplify the light pulse train. The light pulse train generated by the first injection of the pump light is of weak pulses whose phase is not fixed, and its phase state is gradually determined by being amplified by the PSA 2 every time it goes around in the ring resonator 1. Since the PSA2 amplifies each light pulse with a phase of 0 or Π with respect to the phase of the pump light source, the phase is determined to be in one of these phase states.

The coherent Ising machine is implemented by causing the spins of 1 and −1 in the Ising model to correspond to the phases 0 and Π of the light pulse. For each circulation of the light pulses, a measurement unit 3 measures a signed amplitude cⱼ in the phase 0 or Π direction for each pulse of the light pulse train. The sign is positive in the phase 0 direction and negative in the phase II direction. With respect to the measurement result, an arithmetic unit 4 to which an adjacency matrix (coupling constant) has been given in advance calculates a coupling signal to be fed back. The coupled signal Δcⱼ to be fed back to the i-th light pulse is expressed by the following expression.

$$Δ {c}_{i} = {\sum }_{j} {J}_{ij} {c}_{j} \qquad [ Math . 2 ]$$

Next, an external light pulse input unit 5 generates an external light pulse according to the calculated coupled signal and inputs the external light pulse into the ring resonator 1. By such feedback loop control, it is possible to impart a correlation to phases between the light pulses constituting the light pulse train. The light pulse train is circularly amplified in the ring resonator 1 while this correlation is given, and the phases 0 and Π of the respective light pulses constituting the light pulse train in the stable state are measured, whereby the solution of the Ising model can be obtained.

Since the coherent Ising machine uses physical properties of light, it is known that, when the number of spins corresponding to the number of sites of the Ising model is 2000, the solution can be found about 50 times faster than in a simulation performed by a normal electronic calculator (see, for example, Non Patent Literature 1.).

In order to investigate characteristics of the finite-temperature Ising model using an electronic calculator, the Markov chain Monte Carlo method is often used, but it is necessary to take a certain length of relaxation time or longer in order to generate a large number of samples in a sufficiently independent spin state. In the case of using the Metropolis method as a typical example, the relaxation time required to obtain independent samples increases as the temperature decreases. In particular, when there is a phase transition in the system, the relaxation time significantly increases in the vicinity of the most interesting phase transition. Therefore, in general, long-time calculation is required to numerically calculate physical properties at a low temperature.

On the other hand, a coherent Ising machine is a physical machine, in which relaxation is fast, and a low energy state of the Ising model can be selected relatively quickly. Therefore, there is a possibility that the coherent Ising machine will be effectively used for sampling of spin states. However, association of temperatures of the Ising model with the machine parameters such as the pump light intensity that determines the operation of the coherent Ising machine, the coupling intensity in the feedback loop control, and the feedback intensity has not been clarified. In addition, due to the problem of stability of the physical system, the direction of biased fluctuation is difficult to temporally fix and periodically fluctuates. As a result, there is a problem that the temperature of samples in the spin state extracted using the coherent Ising machine cannot be specified.

### CITATION LIST

### Non Patent Literature

Non Patent Literature 1: T. Inagaki et al., “A coherent Ising machine for 2000-node optimization problems”, Science. 354, 603 (2016).
Non Patent Literature 2: F. Wang and D. P. Landau, “Efficient, Multiple-Range Random Walk Algorithm to Calculate the Density of States”, Phys. Rev. Lett. 86, 2050 (2001).

### SUMMARY OF INVENTION

An object of the present invention is to provide a calculation device that simulates spin states of a finite-temperature Ising model by combining characteristics of a coherent Ising machine and an electronic calculator.

In order to achieve the objective, an aspect of the present invention is a calculation device for a finite-temperature Ising model, the calculation device including a coherent Ising machine including a sampling unit that samples a spin state, the sampling unit introducing a check spin for extracting a sample in addition to a target spin for solving a target problem for which a solution of the Ising model is to be obtained, and an electronic calculator including a temperature estimation unit that calculates a temperature or an inverse temperature of a sample in a spin state extracted by the sampling unit, and an integration processing unit that integrates a plurality of samples and performs statistical processing.

### BRIEF DESCRIPTION OF DRAWINGS

FIG. 1 is a diagram illustrating a basic configuration of a conventional coherent Ising machine.

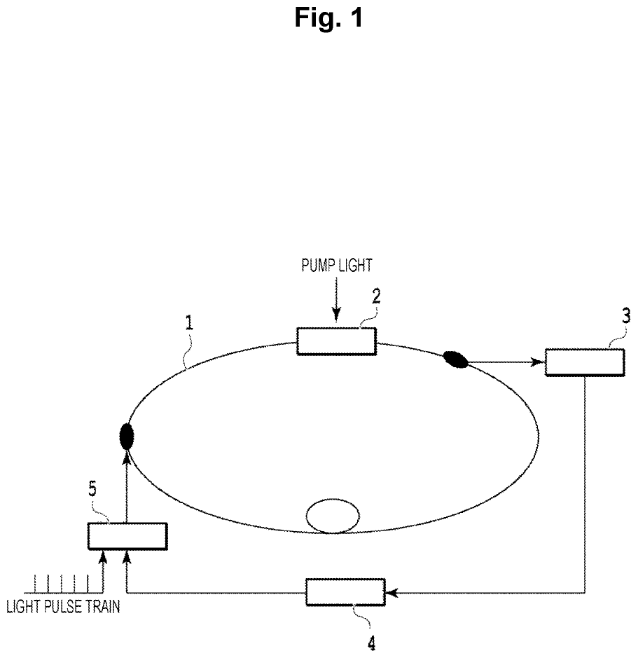

FIG. 2 is a diagram illustrating a calculation device for a finite-temperature Ising model according to an embodiment of the present invention.

FIG. 3 is a graph showing inverse temperature dependency of an internal energy of the Ising model.

FIG. 4 is a graph showing inverse temperature dependency of root mean square magnetization per spin of the Ising model.

### DESCRIPTION OF EMBODIMENTS

A detailed description of embodiments of the present invention will be described below with reference to the drawings.

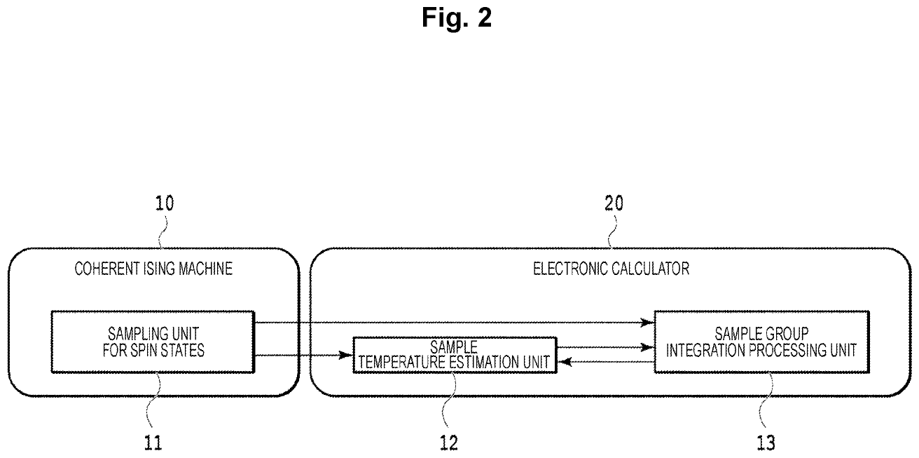

FIG. 2 illustrates a calculation device for a finite-temperature Ising model according to an embodiment of the present invention. The calculation device for the finite-temperature Ising model simulates the spin state of the finite-temperature Ising model by combining characteristics of a coherent Ising machine and an electronic calculator. The calculation device for the finite-temperature Ising includes a sampling unit 11 for spin states mounted on a coherent Ising machine 10, and a sample temperature estimation unit 12 and a sample group integration processing unit 13 mounted on an electronic calculator 20.

The coherent Ising machine 10 causes the sampling unit 11 for spin states to sample spin states at high speed. The sample temperature estimation unit 12 uses statistical inference such as maximum likelihood estimation to estimate temperature or inverse temperature (the inverse number of the temperature) of the extracted samples through calculation by the electronic calculator 20. The sample group integration processing unit 13 integrates the sample groups whose temperature has been estimated, performs statistical processing, and calculates and outputs thermodynamic quantities, correlation functions, and the like.

The sampling unit 11 for spin states introduces check spins and samples the spin states. The check spins are spins (light pulse) introduced to extract samples, in addition to the light pulse constituting a light pulse train corresponding to a site of the Ising model, that is, the spins (target spins) used to solve the problem (target problem) to which the solution is to be obtained. The check spins are arranged in a distributed manner and are inserted throughout the light pulse train to ensure that there is no bias in the extraction of the spin states. The arrangement positions may be determined completely randomly or evenly throughout the light pulses of the Ising model.

The distributed arrangement of the check spins can be specifically represented using a permutation matrix P. A case in which there are a total of (M+N) spins including the check spins and the target spins, with serial numbers given, the first M spins represent the check spins, and the next N spins represent the target spins will be considered. At this time, the following correspondence relationship is established between the order i of the optical pulse train in the coherent Ising machine and the order of the entire spins set above.

$$i ↔ {{\sum }^{M + N}}_{j = 1} {P}_{ij} j \qquad [ Math . 3 ]$$

Here, the left side represents the order of light pulses, and the right side represents the order of the entire spins. The check spins are combined using an adjacency matrix J^{check} of the check problem with a known solution. At this time, the adjacency matrix J set in advance in the arithmetic unit 4 is an augmented matrix as follows obtained by directly summing the adjacency matrix J^{target} of the target problem and the adjacency matrix J^{check} of the check problem and then permuting the matrices.

$$J = P ( \begin{matrix}{J}^{check} & 0 \\ 0 & {J}^{target}\end{matrix} ) {P}^{T} \qquad [ Math . 4 ]$$

Next, the coherent Ising machine is operated, and M+N total spin states are acquired from the measurement result of the signed amplitude of the measurement unit 3 as follows.

$${σ}_{i} = sign ( {c}_{i} ) ( i = 1 , ... M + N ) \qquad [ Math . 5 ]$$

By using the above-described correspondence relationship, all of the spin states are divided into check spin states and the target spin states as follows.

$${σ}_{i}^{check} ( i = 1 , ... , M ) \qquad [ Math . 6 ]$$

$${σ}_{i}^{target} ( i = 1 , ... , N ) \qquad [ Math . 7 ]$$

Using these states, Ising energy of the check problem and Ising energy of the target problem are calculated.

$${E}_{check} = - {\sum }_{ij} {J}_{ij}^{check} {σ}_{i}^{check} {σ}_{j}^{check} \qquad [ Math . 8 ]$$

$${E}_{target} = - {\sum }_{ij} {J}_{ij}^{target} {σ}_{i}^{target} {σ}_{j}^{target} \qquad [ Math . 9 ]$$

Whether the obtained spin state samples are reliable, that is, whether the coherent Ising machine is operating stably is determined based on whether check Ising energy E_{check} satisfies a preset threshold. Only when the above sampling is repeated and E_{check} satisfies the condition, a set of a target spin state vector and the target Ising energy (σ_{target}, E_{target}) is created and extracted as a sample.

The sample temperature estimation unit 12 uses the extracted spin state samples to statistically estimate a temperature or an inverse temperature that is likely to have the canonical distribution of the spin states. This is called temperature of samples or inverse temperature. The electronic calculator 20 is used for this estimation. Here, the calculation result when the maximum likelihood estimation method is used will be described. Assuming that the population of the target spin states of the samples is canonical, the maximum likelihood estimation value βₛₐₘₚₗₑ of the inverse temperature of the samples satisfies the following expression.

$$U ( {β}_{sample} ) = {E}_{sample} \qquad [ Math . 10 ]$$

Here, the function U(β) is internal energy of the Ising model in the thermal equilibrium state having the inverse temperature β as a variable, and the energy Eₛₐₘₚₗₑ on the right side is the sample mean of E_{target}. The internal energy in the thermodynamically stable equilibrium state is continuous and monotonically decreases with respect to the inverse temperature. In particular, in a finite spin system, since a smooth function is obtained, the inverse function of U(β) always exists.

Therefore, inverse temperature dependence U(β) of internal energy is calculated by the electronic calculator 20, and then the inverse function U⁻¹ (E) is numerically obtained. The average energy E of the extracted samples of the spin states is substituted into a variable of the calculated inverse function U⁻¹ (E) to obtain an estimated value βₛₐₘₚₗₑ of the inverse temperature.

$${β}_{sample} = {U}^{- 1} ( {E}_{sample} ) \qquad [ Math . 11 ]$$

Although it is necessary to obtain the internal energy function U(β) in advance in this method, the internal energy function U(β) can be obtained with relatively low accuracy with a small calculation amount even with the electronic calculator 20 by using a Markov chain Monte Carlo method such as the Wang-Landau method (see, for example, Non Patent Literature 2). The reason for this will be described below.

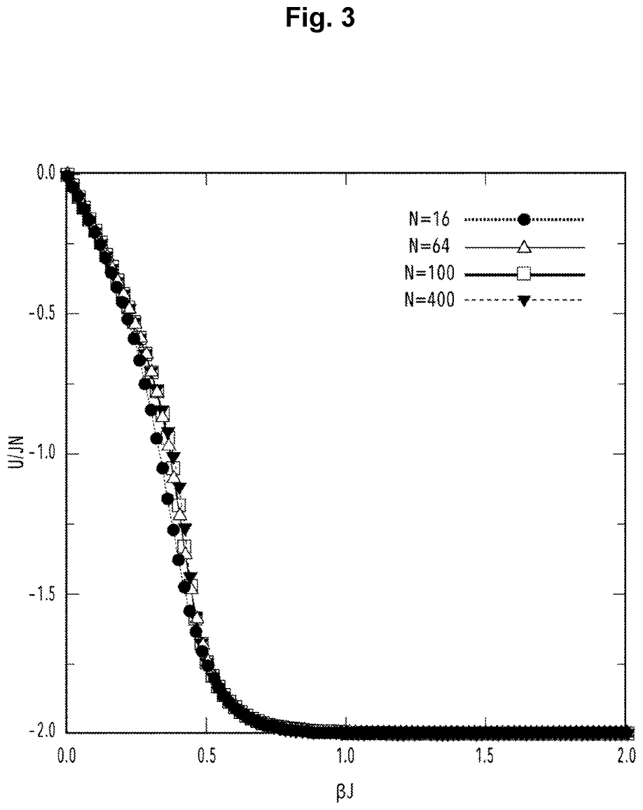

FIG. 3 shows inverse temperature dependency of internal energy of the Ising model. The graph shows dependency of the internal energy U on the inverse temperature β with respect to a ferromagnetic material on a two-dimensional square lattice obtained using the Wang-Landau method. As is obvious from FIG. 3, since the internal energy U is a thermodynamic index variable, convergence per spin is fast. In addition, since the internal energy U can be obtained by extracting a state density, that is, samples in a spin state at a high temperature limit, quick relaxation can be expected even if the electronic calculator 20 is used.

Further, since more important information about a thermodynamic amount such as specific heat is included in a higher-order differential amount of internal energy, when samples are extracted directly from the electronic calculator 20, a larger calculation amount than that at a low temperature is required as described above. In addition, an error δβₛₐₘₚₗₑ of the estimated inverse temperature of the samples greater than zero (δβₛₐₘₚₗₑ>0) can be estimated by the following expression.

$${δβ}_{sample} \approx \frac{1}{\sqrt{n Δ U ( {β}_{sample} )}} \qquad [ Math . 12 ]$$

Where, n is the number of samples.

$$Δ U ( β ) ≡ {〈 {( H - U ( β ) )}^{2} 〉}_{β} \qquad [ Math . 13 ]$$

The above expression is the energy variance of the Ising model at the inverse temperature β. An energy variance function ΔU(β) having the inverse temperature β as a variable can also be obtained from the Wang-Landau method or the like. However, it should be noted that accuracy of the energy dispersion function is lower than that of the internal energy function U(β). As a substitute for ΔU(β) in the expression, an unbiased variance of the target Ising energy of the samples may be used.

The sample group integration processing unit 13 combines the results of the sampling unit 11 for spin states and the sample temperature estimation unit 12 to perform integration and statistical processing of the plurality of samples the electronic calculator 20. That is, the samples having a plurality of sets (σ_{target}, E_{target}) sets obtained by the sampling unit 11 is labeled with the inverse temperature βₛₐₘₚₗₑ. Next, various thermodynamic amounts such as magnetization, specific and heat, magnetic susceptibility, correlation functions, and the like are calculated using the target spin state σ_{target} in the samples, and are output in combination with βₛₐₘₚₗₑ. When there are a plurality of samples, a plurality of samples having a similar inverse temperature βₛₐₘₚₗₑ may be collectively treated as one sample, and the inverse temperature of the integrated sample may be estimated again using the sample temperature estimation unit 12 described above.

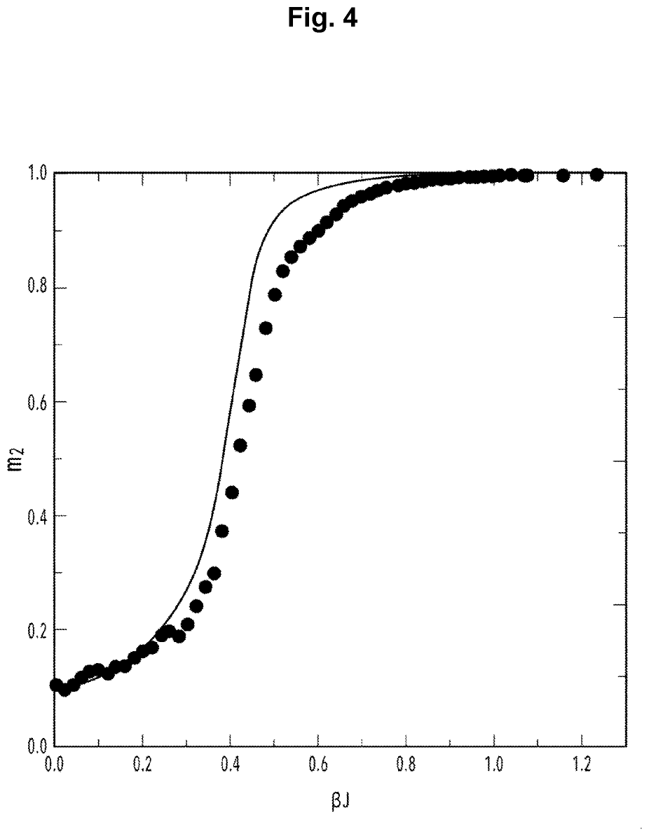

FIG. 4 shows inverse temperature dependency of root mean square magnetization per spin of the Ising model. It is the results obtained through statistical calculation when it is of the Ising model of a ferromagnetic material on a two-dimensional square lattice, the number of spins N is 100, and the coupling constant is represented by J. It can be seen that the obtained experimental data (black dots) exhibits expected results with theoretical values (thin lines).

1. A calculation device for a finite-temperature Ising model, the calculation device comprising:
a coherent Ising machine including a sampling unit configured to sample a spin state, the sampling unit introducing a check spin for extracting a sample in addition to a target spin for solving a target problem for which a solution of the Ising model is to be obtained; and
an electronic calculator including a temperature estimation unit configured to calculate a temperature or an inverse temperature of a sample in a spin state extracted by the sampling unit, and an integration processing unit configured to integrate a plurality of samples and perform statistical processing.

2. The calculation device for an Ising model according to claim 1, wherein the sampling unit arranges the check spin in the target spin in a distributed manner by using an augmented matrix obtained by directly summing an adjacency matrix for solving the target problem and an adjacency matrix of a check problem with a known solution and then permuting the matrices.

3. The calculation device for an Ising model according to claim 1, wherein the temperature estimation unit statistically estimates a temperature or an inverse temperature that is likely to have a canonical distribution of the spin states using the samples of the spin states extracted by the sampling unit.

4. The calculation device for an Ising model according to claim 2, wherein the sampling unit divides spin states into spin states of the target problem and spin states of the check problem and calculates an Ising energy of each spin state, and extracts a set of the spin states of the target problem and the Ising energy of the target problem as a sample when the Ising energy of the check problem satisfies a preset threshold.

5. The calculation device for an Ising model according to claim 4, wherein the temperature estimation unit calculates inverse temperature dependency of an internal energy, and substitutes a sample mean of the Ising energy of the target problem into an inverse function of the calculation result to obtain an estimated value of the inverse temperature.

6. The calculation device for an Ising model according to claim 5, wherein the integration processing unit performs statistical processing by integrating a plurality of samples having a similar inverse temperature based on a sample that is a set of the spin states of the target problem and the Ising energy of the target problem and an estimated value of the inverse temperature estimated by the temperature estimation unit.

7. The calculation device for an Ising model according to claim 2, wherein the temperature estimation unit statistically estimates a temperature or an inverse temperature that is likely to have a canonical distribution of the spin states using the samples of the spin states extracted by the sampling unit.
